(19) United States
(12) Patent Application Publication
(10) Pub. No.: US 2008/0071434 A1
(43) Pub. Date: Mar. 20, 2008

(54) METHOD AND DEVICE FOR MODIFYING A FLIGHT PLAN AND NOTABLY A TAKEOFF PROCEDURE FOR AN AIRCRAFT

(75) Inventors: Stephanie FORTIER, Cugnaux (FR); Manuel GUTIERREZ-CASTANEDA, Toulouse (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-sur-Seine (FR)

(21) Appl. No.: 11/857,635

(22) Filed: Sep. 19, 2007

(30) Foreign Application Priority Data
Sep. 19, 2006 (FR) 06 08183

(51) Int. Cl. G06F 19/00

(52) U.S. Cl. 701/15

(57) ABSTRACT

The present invention relates to a method and its associated device for preparing an initial flight plan. The initial flight plan includes an initial takeoff procedure comprising a takeoff runway associated with an SID procedure, signifying instrument departure procedure with one or more routes described by waypoints. The method according to the invention has a first step of inputting at least one optional takeoff procedure. The takeoff procedure has at least one takeoff runway procedure and an associated SID procedure. A second step includes selecting takeoff procedure from among the optional takeoff procedures.

### RELATED APPLICATIONS

The present application is based on, and claims priority from France Application Number 06 08183, filed Sep. 19, 2006, the disclosure of which is hereby incorporated by reference herein in its entirety.

### BACKGROUND OF THE INVENTION

The present invention relates to the adaptation of a flight plan to a change of initially scheduled takeoff runway, notably, during the preflight phase during which an aircraft goes to its takeoff runway after having received the instruction to do so from an airport traffic control authority.

### DESCRIPTION OF THE PRIOR ART

A flight plan pools together informations on the conduct of the flight. It relies on a chronological sequence of waypoints tagged by their geographical positions and associated with constraints of regulatory origin (altitude, capture heading, etc.), chronological constraints (transit time), and constraints related to the type of the aircraft and also its performance at the time. The flight plan is followed either manually by the pilot of the aircraft, or automatically by an FMS flight management computer (the acronym standing for: “Flight Management System”) which controls automatic piloting facilities (Automatic pilot or Flight director) and which is programmed via an MCDU man-machine interface (the acronym standing for: “Multifunction Control Display Unit”) making it possible to enter the flight plan and to display information about the course of a current flight plan.

In the case of an aircraft belonging to an airline transport fleet, the drawing up of a flight plan being relatively complex and making it necessary to allow for the meteorological situation encountered on the journey, it is carried out by specialists on land, during a preparatory step just prior to the flight. Once drawn up, it is entered into the flight management computer of the aircraft by the usual computer means (keyboard, removable memory medium, transmission of data, etc.) which are also at the disposal of the pilot.

Usually, the first waypoint of a flight plan is the takeoff runway. Associated therewith are a certain number of flight parameters which are fixed as a function of the aircraft's flight performance at the time, which allow the pilot to ensure takeoff under optimal conditions and allow the FMS computer to ensure that the takeoff goes according to plan by generating if required the appropriate alerts. With each takeoff runway is associated one or more sequences of compulsory waypoints, accompanied by the flight constraints, designated by the name SID instrument departure procedures (the acronym standing for the term: “Standard Instrument Departure”).

The density of air traffic on certain airports is such that during certain periods of heavy traffic, the queues before takeoff are significant. It is then opportune to be able to profit from the momentary availability of another takeoff runway so as to reduce the waiting time before takeoff and to comply with the timetables scheduled for the flight. To modify the takeoff runway, the only alternative for the pilot is to completely redefine the departure procedure with the associated performance parameters. However, it is not always possible for the pilot to perform this manipulation, specifically, during the phase prior to takeoff all his attention is required on head-up equipment as well as on the conduct of the aircraft while rolling. Additionally, very good reactivity on the part of the crew is necessary since the availability slot of an alternative runway is often very short. The redefining of a takeoff procedure is therefore, under these conditions, very difficult and might imperil the safety of the flight during this phase.

A secondary flight plan, comprising an alternative takeoff runway, may nevertheless be available to the pilot beforehand in the FMS computer. However, in actual fact, this alternative runway is rarely the one proposed for takeoff and the difficulties remain the same.

### SUMMARY OF THE INVENTION

One of the objectives of the invention is notably to alleviate the aforesaid drawbacks. For this purpose, the invention is aimed at a method for modifying a takeoff procedure of an initial flight plan. A flight plan notably comprises:
an initial takeoff procedure comprising a takeoff runway associated with an SID procedure, signifying instrument departure procedure,
one or more routes described by waypoints.

The method according to the invention can comprise several successive steps including:
a first step of inputting at least one optional takeoff procedure, a takeoff procedure comprising at least one takeoff runway and an associated SID procedure,
a second step of selecting a takeoff procedure from among the optional takeoff procedures,
a third step of activating the selected takeoff procedure.

The method according to the invention can also comprise a step of checking the optional takeoff procedures input.

The inputting step of the method according to the invention can also make it possible to modify and/or to remove one or more pre-existing optional takeoff procedures.

A device for implementing the method according to the invention can for example comprise means:
for inputting an initial flight plan,
for inputting optional takeoff procedures,
for checking the takeoff procedures input,
for selecting an optional takeoff procedure,
for activating the chosen optional takeoff procedure,
for displaying the trajectory of the initial flight plan and trajectories of the optional takeoff procedures,
for modifying, for removing the pre-existing optional takeoff procedures,
for transmitting the optional takeoff procedures via an operational data link between the aircraft and its airline,
for aiding input of the optional takeoff procedures.

By virtue of the method and device according to the invention, several optional takeoff procedures can be input in an anticipated and simple manner. Among the optional takeoff procedures, the one ultimately chosen can be rapidly activated thereby making it possible to boost the reactivity of the crew when redefining the initial takeoff procedure. The method and the device according to the invention also make it possible to increase the safety of the flight, to optimize its performance, and thus to limit the fuel consumption of the aircraft.

### BRIEF DESCRIPTION OF THE DRAWINGS

Other characteristics and advantages of the invention will appear with the aid of the description which follows, offered in relation to the appended drawings which represent:

FIG. 1: an architecture diagram of a known flight plan management system;

FIG. 2: an interface for inputting the optional takeoff procedures according to the invention;

FIG. 3: an interface for inputting the data relating to an optional takeoff procedure according to the invention;

FIG. 4: an example of allowing for an optional takeoff procedure in a flight plan according to the invention;

FIG. 5: an interface for presenting and activating an optional takeoff procedure according to the invention;

FIG. 6: a schematic of the successive phases of the method according to the invention.

### DETAILED DESCRIPTION OF A PREFERRED EMBODIMENT

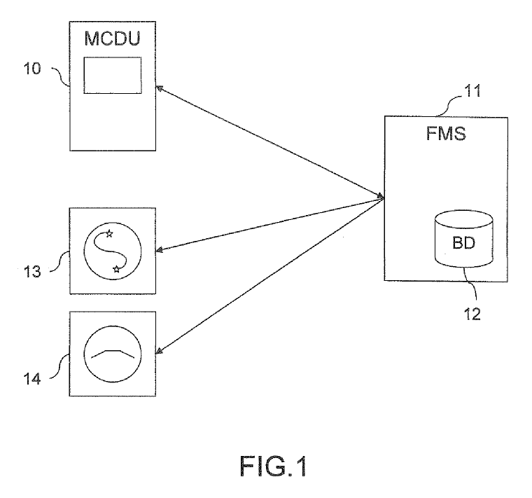

FIG. 1 presents an exemplary architecture diagram of a flight plan management system. This management system on board an aircraft comprises inter alia a module of “Multifunction Control Display Unit” type 10 or MCDU. The MCDU 10 is an integrated device comprising a screen and a keyboard that is fairly widespread in avionics. This module makes it possible notably to input all the data relating to the flight plan such as for example the takeoff procedure. It also offers an interface making it possible to view the information relating to the flight plan.

The data relating to the flight plan that are input by means of the MCDU 10 are thereafter transmitted to an FMS flight management computer 11 so that it draws up the trajectory of the flight plan by taking account of aeronautical data stored in a database BD 12. This trajectory is thereafter broadcast to the MCDU 10 for alphanumeric display in the form of a list of waypoints associated with flight parameters. The trajectories can also be displayed in a graphical manner by one or more displays 13, 14, either in a view from above to depict the lateral profile of the flight, or in a view in cross-section so as to see the vertical profile of the flight, or else in three dimensions. It is possible for example to use one display 13 to represent the vertical profile of the trajectory and another display 14 to represent the horizontal profile.

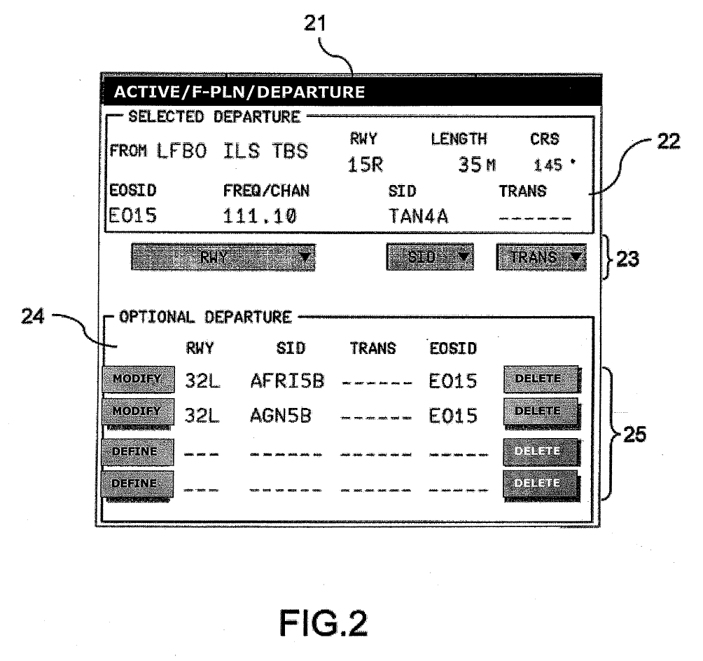

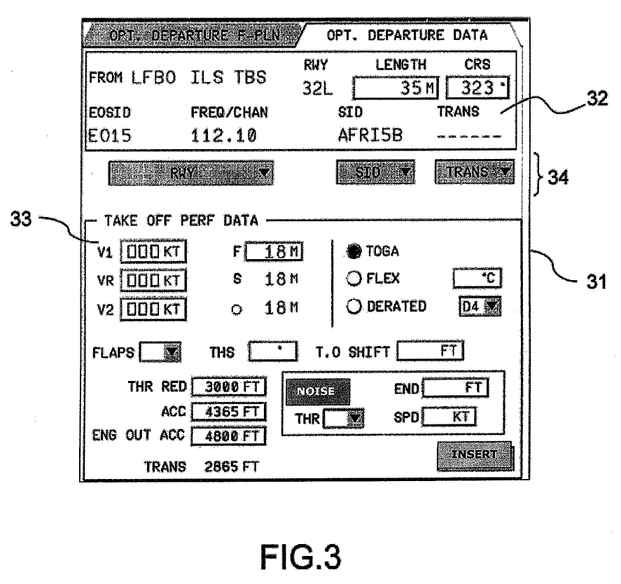

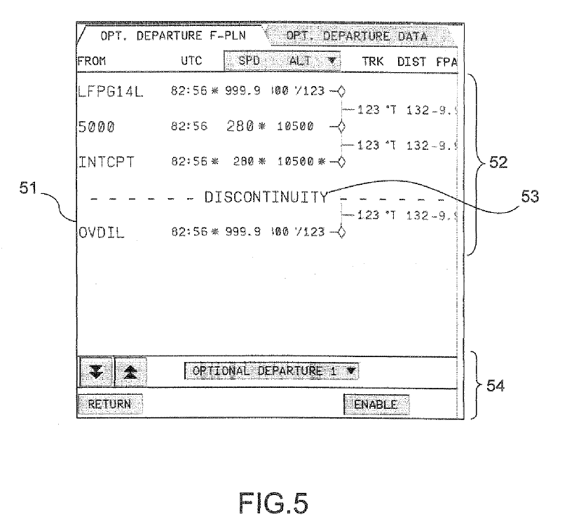

FIG. 2 represents an exemplary panel 21 for inputting active takeoff procedures, or ACTIVE F-PLN DEPARTURE, such as it may be presented to the pilot aboard the aircraft. This panel 21, as well as those presented in FIGS. 3 and 5, can for example be displayed on the screen of an MCDU 10.

The panel 21 allows the pilot to choose a takeoff runway RWY, the acronym standing for the term “runway”, and the associated takeoff procedures may comprise an SID, “Standard Instrument Departure” signifying instrument departure procedure, and possibly a TRANS, or transition procedure, and may be integrated with the active flight plan. This panel 21 also makes it possible to enter the optional takeoff procedures into the FMS computer 11 or to modify optional takeoff procedures already entered. This can be done for example at the time of flight preparation. Moreover, during the flight preparation phase, all the necessary checks of the procedures input can be carried out, the pilot not being occupied with other tasks.

The panel 21 presents several frames: a first frame 22 named SELECTED DEPARTURE presents the initial takeoff procedure of the flight plan. A series of buttons 23 makes it possible to specify certain parameters of the initial takeoff procedure of the flight plan. A second frame 24 named OPTIONAL DEPARTURE presents the various optional procedures input by the pilot.

This panel 21, as well as the panels represented in FIGS. 3 and 5, is a man-machine interface, it makes it possible at one and the same time to consult information and to modify it. Each field of this panel possesses a label which designates it as for example RWY and a value which is in general specified alongside or under the label, such as for example 15R. In our example, this signifies that the name of the runway or RWY is 15R.

The first frame 22, SELECTED DEPARTURE, makes it possible to present the pilot with the takeoff procedure advised in the active flight plan, which corresponds to the initially prepared flight plan. The frame 22 notably advises the pilot regarding:
a departure airport via a field FROM,
the initial takeoff runway via a field RWY,
a length of the initial runway via a field LENGTH,
a precise orientation of the runway via a field CRS, the acronym standing for the term “course”,
an emergency clearance procedure via a field EOSID, the acronym standing for “Engine Out Standard Instrument Departure”,
a frequency of emission of the beacon relating to the runway via a field FREQ/CHAN, the acronym standing for “Frequency/Channel”,
the standard instrument departure procedure via an SID field,
as well as possibly the transition procedure for going between the SID procedure and the first route or RWY of the flight plan via a field TRANS.

The takeoff procedure of the active flight plan can be modified notably by way of the buttons 23 which allow the pilot to select:
a runway by clicking on the RWY button and by selecting one of the runways proposed by the system,
an SID procedure by clicking on the SID button and by selecting one of the SIDs proposed by the system, and
possibly a TRANS procedure by clicking on the TRANS button and by selecting one of the TRANSs proposed by the system.

Once the runway has been selected, the interface advantageously proposes SID procedures compatible with the chosen runway to the pilot. Likewise when the SID procedure is defined, the interface proposes TRANS procedures that are compatible with the selected SID.

The second frame 24, OPTIONAL DEPARTURE, presents the list of optional takeoff procedures that were advised beforehand. Each line 25 represents an optional takeoff procedure. Each optional takeoff procedure includes the fields: runway or RWY, associated SID procedure, possible transition procedure or TRANS and emergency clearance procedure EOSID. Each optional takeoff procedure can be:
created, by selecting for example the DEFINE button on a blank line,
modified, by selecting for example the MODIFY button on the line concerned,
removed, by selecting for example the DELETE button on the line concerned.

FIG. 3 represents the panel 31, named OPT. DEPARTURE DATA, allowing input of complementary information about the aircraft's performance associated with an optional takeoff procedure. The pilot can for example access this table by selecting the MODIFY or DEFINE button corresponding to the chosen optional procedure presented on the panel 21 of FIG. 2. The panel 31 can comprise two frames 32, 33.

A first frame 32 presents the same information as the frame 22, named SELECTED DEPARTURE, presented in the previous figure. This frame 32 makes it possible notably to present: the runway RWY as well as an SID procedure and a TRANS transition procedure, for an optional takeoff procedure.

The buttons 34 make it possible, as on the panel 22 represented in FIG. 2, to select: a runway RWY, an SID procedure and a possible TRANS transition procedure by clicking on the corresponding button. For each chosen procedure the FMS computer proposes the procedures that are compatible with the already advised procedures: for example, the system can propose an SID if the runway has already been selected or a TRANS if the SID has already been selected.

A second frame 33 named TAKE OFF PERF DATA allows the pilot to input all the information relating to the aircraft's current performance and applicable to the takeoff phase, such as for example the speeds V1, V2, V3 which correspond to the speeds that must be reached during the various phases of takeoff.

Once all the runways and optional procedures have been completed, the FMS computer 11 can propose an update of the flight plan comprising a possible point of convergence with the rest of the initially scheduled flight plan.

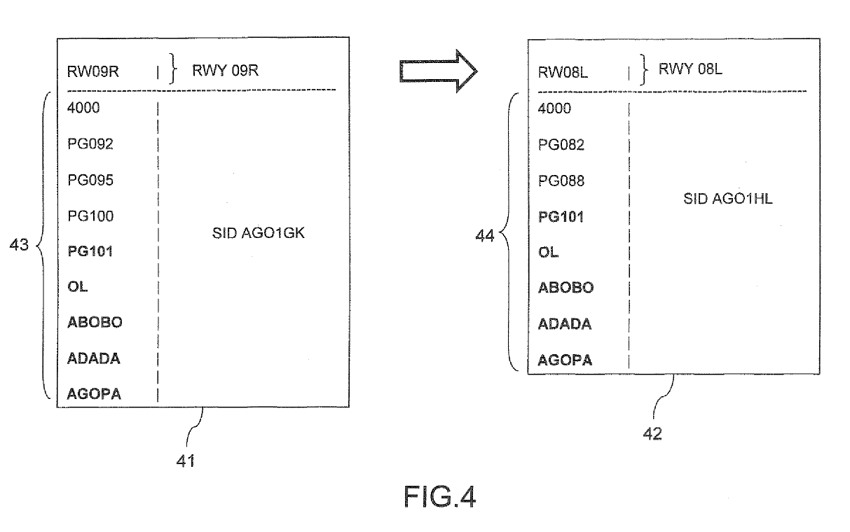

FIG. 4 presents an exemplary modification of the initial takeoff procedure 41. The initial procedure, represented in the form of a list, is composed of a runway named RWY09R, and of a series of waypoints 43 comprising an SID procedure named AGO1GK.

The pilot inputs a new optional takeoff procedure 42 presented in the form of a list of waypoints 44. This new takeoff procedure uses a new runway named RWY08L. The system then proposes a default SID procedure: the AGO1HL SID procedure. The first common waypoint between the SID procedure and the initial flight plan is the point PG101; the convergence between the active flight plan and the optional takeoff procedure takes place therefore by defaulting at the point PG101. Here the system therefore proposes a simple solution so as to ensure the continuity of the flight plan in the case of a last minute change of takeoff runway.

FIG. 5 presents an example of a display panel 51 for a flight plan comprising an optional takeoff procedure. Once the runway and the associated procedures have been recorded by the FMS computer, the pilot has the possibility of consulting a flight plan comprising the entirety of an optional procedure, from the takeoff runway up to the point of convergence with the active flight plan in the form of a list of waypoints 52.

FIG. 5 presents a case of discontinuity 53, denoted DISCONTINUITY, with the rest of the initial flight plan. Specifically, following replacement of the initial takeoff procedure with an optional takeoff procedure, the FMS computer is not always able to automatically ensure transition between the optional takeoff procedure and the rest of the active flight plan. The FMS computer can then propose a transition between the optional takeoff procedure and the active flight plan by way of a discontinuity 53. This discontinuity 53 does not prevent the optional procedure from being able to be activated and followed by the airplane up to the discontinuity point. Onwards of this discontinuity point, the system for tracking the flight plan may break down, no longer being able to ensure continuity of tracking of the flight plan. The pilot has the possibility of removing this discontinuity in the flight plan by modifying the proposed flight plan. He can for example add or remove waypoints so as possibly to link the optional takeoff procedure to the active flight plan.

The panel 51 furthermore possesses a frame 54 which notably allows the pilot to select the optional procedure that he wishes to display via the pop-up menu named OPTIONAL DEPARTURE, signifying operational departure. He can also exit the panel 51 by virtue of the RETURN button to go back to the panel 21 represented in FIG. 2.

The activation of an optional runway displayed on the panel 51 can be performed by the pilot. This activation is done from the panel 51 by selecting for example the insertion button or INSERT to construct a temporary flight plan which includes the new takeoff procedure, thus replacing the initial takeoff procedure in the flight plan. Activation of the temporary flight plan by the pilot thereafter validates the modification of the initial takeoff procedure and allows the FMS system to recompose the active flight plan.

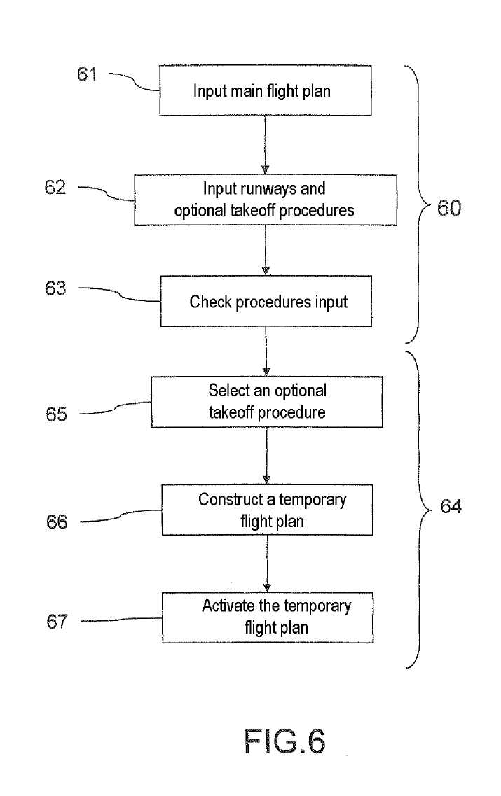

FIG. 6 presents an exemplary implementation of the various steps of the method according to the invention. During a first phase 60 of flight preparation, the initial flight plan can be input on the MCDU 10, according to the flight plan provided by the airline, during a first step 61. The main flight plan having been input, a second step 62 can make it possible to input the runways and optional takeoff procedures by way of the panels 21, 31 presented in FIGS. 2, 3. The optional procedures thus input can be for example transmitted to the airline by way of a messaging of AOC type, the acronym standing for the term “Airline Operational Communication”, by using for example the free fields present in the messages dedicated to the flight plans.

The following step 63 is a step allowing a check of the procedures input. This check is performed by the FMS 11 in part and by the pilot who can graphically depict the trajectory of the flight plan input. The pilot can for example depict on one and the same screen 13, represented in FIG. 1, the trajectory of the initial flight plan as well as the trajectories of the optional takeoff procedures. This display makes it possible to check convergence of the various optional takeoff procedures with the rest of the initial flight plan. The pilot can also check continuity between the takeoff procedure input and the rest of the flight plan by virtue of the panel 51 represented in FIG. 5.

During the rolling phase 64 preceding takeoff the pilot, when he receives the order to do so from air traffic control on the ground, may be induced to change takeoff runway and therefore initial takeoff procedure. It then suffices for the pilot, during a step 65, to consult the whole set of optional procedures input beforehand via the panel 21 represented in FIG. 2, then for example to select an optional procedure via the MODIFY button corresponding to the chosen optional procedure. The pilot then accesses the panel 51 represented in FIG. 5. He then merely needs to select the ENABLE button of the panel 51 to replace the initial takeoff procedure of the flight plan with the chosen optional procedure. The following step 66 is the construction by the FMS computer of a temporary flight plan comprising the chosen optional procedure. This temporary flight plan can be activated by the pilot in another step 67. The temporary flight plan then replaces the part of the initial flight plan comprising the takeoff procedure in the FMS computer and the selected takeoff procedure is thus activated. The active flight plan including the new optional procedure is then made available to the pilot, via the MCDU 10, and other onboard systems such as the automatic pilot.

The method according to the invention possesses numerous advantages, among which is the fact that the ability to anticipate the changes of takeoff runway allows the pilot to be very reactive when this involves modifying the runway and initial takeoff procedure. A check of all the optional procedures input can be performed during the flight preparation phase so as to eliminate any trajectory problem. The manipulations for selecting and activating a new takeoff procedure are advantageously reduced and fast, still with the aim of gaining the pilot time during a phase in the course of which his attention must be directed at the head-up flight equipment or at the canopy so as to steer the aircraft during rolling, and not at the MCDU 10.

The various optional takeoff procedures input can be advantageously checked and allowed for by the FMS 11 so as to optimize the performance of the aircraft with a view to saving fuel during this takeoff phase.

Advantageously also, the panels of the proposed interfaces employ the same elements as the panel for inputting the initial takeoff procedure, which does not give rise to any difficulties of particular manipulation for comprehending this new method and device.

The FMS system 11 needs to manage only a single active flight plan, each optional procedure being advantageously tied to the main flight plan. This makes it possible to optimize the calculations performed as well as the management of the data with respect to a solution according to the prior art which consisted in allowing for several different flight plans.

1. A method of modifying a takeoff procedure of an initial flight plan, comprising the steps of:
an initial takeoff procedure comprising a takeoff runway associated with an SID procedure, signifying instrument departure procedure,
one or more routes described by waypoints,
the method comprising several successive steps:
a first step of inputting at least one optional takeoff procedure, a takeoff procedure comprising at least one takeoff runway and an associated SID procedure, and
a second step of selecting a takeoff procedure from among the optional takeoff procedures input.

2. The method as claimed in claim 1, comprising a third step of activating the selected takeoff procedure.

3. The method as claimed in claim 1, comprising a step of checking the optional takeoff procedures input.

4. The method as claimed in claim 1, wherein the inputting step further includes modifying and/or removing one or more pre-existing optional takeoff procedures.

5. A device for implementing the method as claimed in claim 1, comprising:
inputting means for inputting an initial flight plan,
inputting means for inputting optional takeoff procedures,
checking means for checking the takeoff procedures input,
selecting means for selecting an optional takeoff procedure,
activating means for activating the chosen optional takeoff procedure.

6. The device as claimed in the claim 5, comprising means for displaying the trajectory of the initial flight plan and trajectories of the optional takeoff procedures.

7. The device as claimed in claim 5, comprising modification means, for removing the pre-existing optional takeoff procedures.

8. The device as claimed in claim 5, comprising means for transmitting the optional takeoff procedures via an operational data link between the aircraft and its airline.

9. The device as claimed in 5, comprising means for aiding input of the optional takeoff procedures.
